(19) United States
(12) Patent Application Publication
(10) Pub. No.: US 2013/0333282 A1
(43) Pub. Date: Dec. 19, 2013

(54) Landscaping Ground Cover System

(71) Applicants: Jeffrey Alan Bisgrove, Placida, FL (US); Jimmy Ray Bisgrove, New Lenox, IL (US)

(72) Inventors: Jeffrey Alan Bisgrove, Placida, FL (US); Jimmy Ray Bisgrove, New Lenox, IL (US)

(21) Appl. No.: 13/523,850

(22) Filed: Jun. 14, 2012

(51) Int. Cl. A01G 13/02

(52) U.S. Cl. 47/32.8; 47/32.7

(57) ABSTRACT

A landscaping ground cover system and method is disclosed having a ground mat. The ground mat has one or more fill boundaries defining a plurality of fill areas. At least one of the plurality of fill areas has a fill label corresponding to a pre-defined ground cover fill material to be filled into the corresponding fill area. The fill boundaries may form a graphic design on the mat.

### FIELD OF THE INVENTION

The invention relates to landscaping ground cover systems that use ground cover fill material.

### BACKGROUND OF THE INVENTION

Ground cover fill material such as mulch is used in landscaping, gardening, and agriculture as ground cover placed over soil for any of a number of reasons, such as to prevent evaporation, maintain even soil temperature, to prevent erosion, to control weeds, to insulate the soil, and/or to beautify the landscape. Often times mulch comprises organic materials such as decaying leaves, straw, tree bark, wood chips, sawdust, compost, or a combination thereof.

Providing a pleasing layout or design to a landscape is an end that many people desire. The present inventors have recognized the need for a system that allows any landscaper to impart a design in the ground cover fill material provided in a landscape. The present inventors recognize a need for a way of assisting ground cover fill material users in placing the ground cover fill material. The present inventors recognize a need for a method of arranging ground cover fill material so as to provide a design or shape to the landscape. The present inventors recognize the need for a ground mat capable of informing a landscaper were various types and colors of ground cover fill material should be placed to achieve a desired design with the ground cover fill material.

### SUMMARY OF THE INVENTION

A landscaping ground cover system is disclosed having a ground mat. The ground mat has one or more fill boundaries defining a plurality of fill areas. At least one of the plurality of fill areas has a fill label corresponding to a pre-defined ground cover fill material to be filled into the corresponding fill area. The fill boundaries may form a graphic design on the mat.

In some embodiments, the fill boundaries are walls extending up from the top surface of the mat.

In some embodiments, the mat is a weed prevention mat permeable to water and air and comprising polypropylene.

In some embodiments, mat comprises a hard plastic. The fill boundaries and fill areas of the mat are formed into the mat. The fill areas are recessed from a top of the fill boundaries.

In some embodiments, each fill area comprises a fill label corresponding to a given ground cover fill material to be filled into the corresponding fill area.

A method of landscaping is also disclosed comprising laying a mat on an exterior surface, such as the ground. The mat has one or more fill boundaries defining a plurality of fill areas on the mat. A first fill area of the plurality of fill areas is filled with a first ground cover fill material. A second fill area of the plurality of fill areas is filled with a second ground cover fill material. The first ground cover fill material differs from the second ground cover fill material by at least one characteristic.

In some embodiments, the at least one characteristic is a ground cover fill material color. In some embodiments, the at least one characteristic is a ground cover fill material type.

In some embodiments the at least one characteristic is a fluorescence, glossiness, or photoluminescence of the ground cover fill material.

In some embodiments, each fill area of the mat comprises a fill label. The first fill area of the plurality of fill is filled with a first ground cover fill material having a first characteristic corresponding to the fill label in the first fill area. The second fill area of the plurality of fill areas is filled with a second ground cover fill material having a second characteristic corresponding to the fill label in the second fill area.

In some embodiments, a fill key is referenced before filling to determine the ground cover fill material that corresponds to the fill label in each fill area.

The mat may be completely covered in each fill area with a predefined corresponding ground cover fill material.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1 is a top perspective view of a mat of a landscaping ground cover system of the invention.

FIG. 2 is a second embodiment mat of the landscaping ground cover system.

FIG. 3 is the mat of FIG. 2 partially covered in sea shell ground cover fill material.

FIG. 3A is a top perspective view of an exemplary sea shell of sea shell ground cover fill material.

FIG. 3B is a side perspective view of an exemplary sea shell of sea shell ground cover fill material.

FIG. 4 is a perspective view of a third embodiment mat of the landscaping ground cover system.

FIG. 5 is a perspective view of a fourth embodiment mat of the landscaping ground cover system.

FIG. 6 is a cross-sectional side view of a fifth embodiment mat of the landscaping ground cover system.

FIG. 7 is a cross-sectional side view of the mat of FIG. 2 illustrating two different types of dividers.

### DETAILED DESCRIPTION OF THE EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

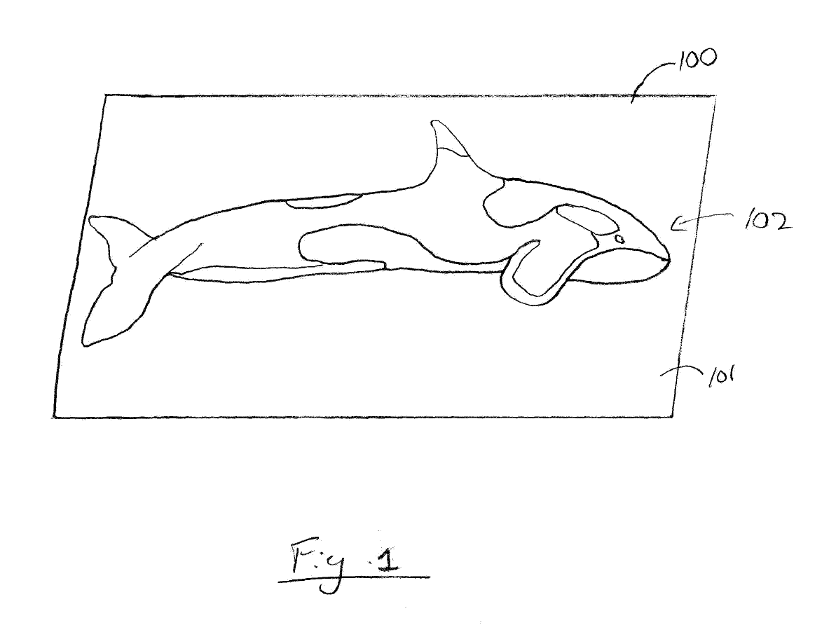

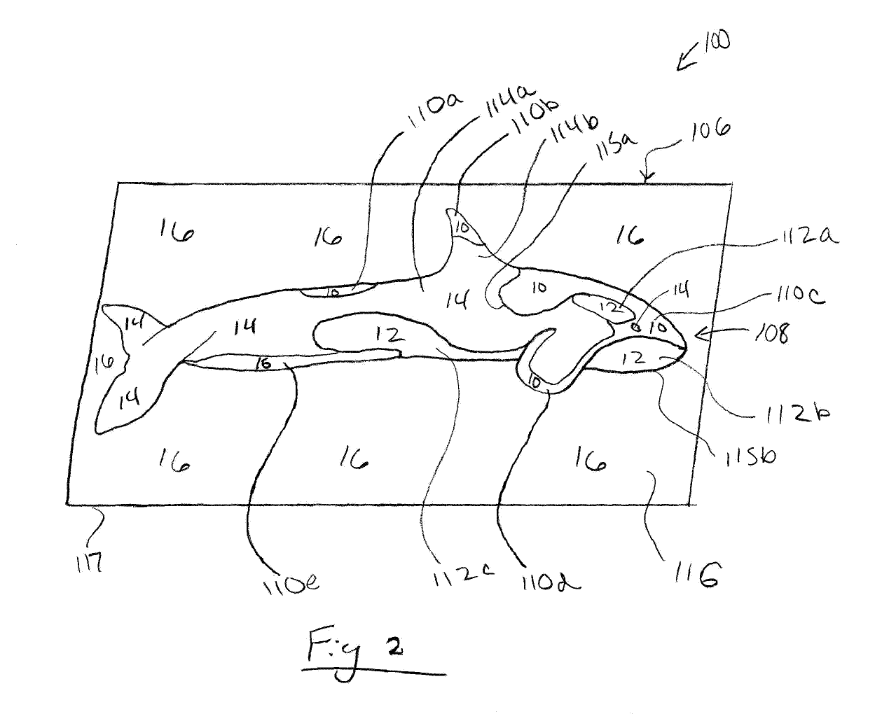

A landscaping ground cover system is disclosed. FIG. 1 shows a mat 100 with a design 102 drawn on a top surface 101 of the mat 100. Second, third, and fourth embodiment mats 106, 135, 145 are shown in FIGS. 2, 4, and 5 respectively. The mats are configured to receive over the top of the mat, ground cover fill material, such as mulch, sea shells, rubber, gravel, and rocks, stone, or other aggregate. Any of such ground cover fill material may be dyed, colored, or coated.

In some embodiments, the mats 100, 106, 135, 145 are a weed mat. The mat may comprise polypropylene, polypropylene, polyester fabric, woven polypropylene, polypropylene spunbond fabric, Polyolefin nonwoven fabric, or a combination thereof or similar material. The mat may be UV-treated to resist the effects of solar rays. The mat may comprise any material known to be used to create a barrier to weed growth while allowing water and air to permeate the mat. In some embodiments, the mat may instead be a hard or flexible plastic barrier that is impermeable to air and water. In some embodiments, the mat may be organic and biodegradable. In some embodiments, the mat may be comprised of plastic. In some embodiments, the mat may comprise paper, cardboard, fibrous cloth material, bark, coco fiber, and/or polymer binder, or any combination thereof. The material of the mat may be pattern bonded, woven, or spunbound. In some embodiments, the mat is perforated. The mat may be configured in a rectangle, square, circle, irregular, or any other shape. In some embodiment, the mat may be capable of being cut to size by a user. In some embodiments, the mat is a sod mat or a seed mat. In some embodiments, the mat represents any sheet-like ground cover that can be laid under mulch in landscaping. In some embodiments, the mat has width of 3 foot, a length of 8 foot, and a height of a 0.25 of an inch. In some embodiments, the upper surface of the mat comprises an adhesive, or an adhesive layer, such as tape or glue, for the purpose of securing ground cover fill material to the surface of the mat.

In some embodiments, the mat 100, 106 includes a design 102, 108. The exemplary design shown in FIGS. 1-3 is that of a whale. However, the design 102, 108 can be any design, such as the design of logos, cartoon characters, landscapes, a building, words, letters, sports mascots, products, abstract art, or any another design that one would like to represent on landscape. As shown in FIG. 2, the design is defined by one or more fill boundaries, such as boundaries 115a, 115b. The fill boundaries define fill areas 110a, 110b, 110c, 110d, 110e, 112a, 112b, 112c, 114a, 114b, 116. In some embodiments, the edges 117 of the mat 106 are also a fill boundary.

In the embodiment shown in FIG. 2, the fill boundaries contain or are labeled with a fill label. The fill labels of the design 108 of FIG. 2 are: fill label 10 corresponding to fill areas 110a, 110b, 110c, 110d, 110e; fill label 12 corresponding to fill areas 112a, 112b, 112b; fill label 14 corresponding to fill areas 114a, 114b; and fill label 16 corresponding to fill area 116. In some embodiments, a key (not shown) is printed on the mat that provides a correlation between the fill labels and the ground cover fill material corresponding to the fill labels that is to be filled in the corresponding fill areas. The key can provide, for example, that black ground cover fill material is to be placed in the fill areas having the number 10, white ground cover fill material is to be placed in the fill areas having the number 12; gray ground cover fill material is to be placed in the fill areas having the number 14, blue ground cover fill material is to be placed in the areas having the number 16, and that black ground cover fill material be placed along the fill boundaries. In some embodiments, the fill key is provided on an instruction sheet rather than printed on the mat. When a landscaper follows this placement-by-number method using colored ground cover fill material as indicated, a resulting colored design, such as a whale, will be shown in the arranged ground cover fill material.

In some embodiments, letters, symbols, words, and/or other indicia are used as fill labels. Any appropriate fill key can provide the correlation between the fill labels and the ground cover fill material to be placed in the corresponding fill area. If words are used, then a fill key may not be necessary. In such an embodiment, black ground cover fill material is to be placed in the fill areas having the word BLACK, white ground cover fill material is to be placed in the fill areas having the word WHITE; gray ground cover fill material is to be placed in the fill areas having the word GRAY, blue ground cover fill material is to be placed in the areas having the word BLUE, and that black ground cover fill material be placed along the fill boundaries. In some embodiments, the mat may not have fill labels and instead the fill key is a color picture of the final completed design, where the landscaper places the appropriately colored ground cover fill material in each fill area as instructed by the fill key picture to achieve a design on the ground that mirrors that in the fill key. The fill key may be printed on the mat or may be printed on a separate sheet of paper.

In some embodiments, the fill areas do not have fill labels, but instead, the fill areas on the mat are pre-painted with the color of ground cover fill material to be filled. Therefore, the area that would have had the label 16, would instead be colored in the color blue. The landscaper would then place the blue color ground cover fill material over the blue fill area.

In some embodiments, the key or the fill label designates not only a color of ground cover fill material but also, or instead, a type of ground cover fill material to be provided in a corresponding fill area. Therefore, the mat can provide a design that incorporates different types of ground cover fill material in different fill areas as indicated by the fill labels.

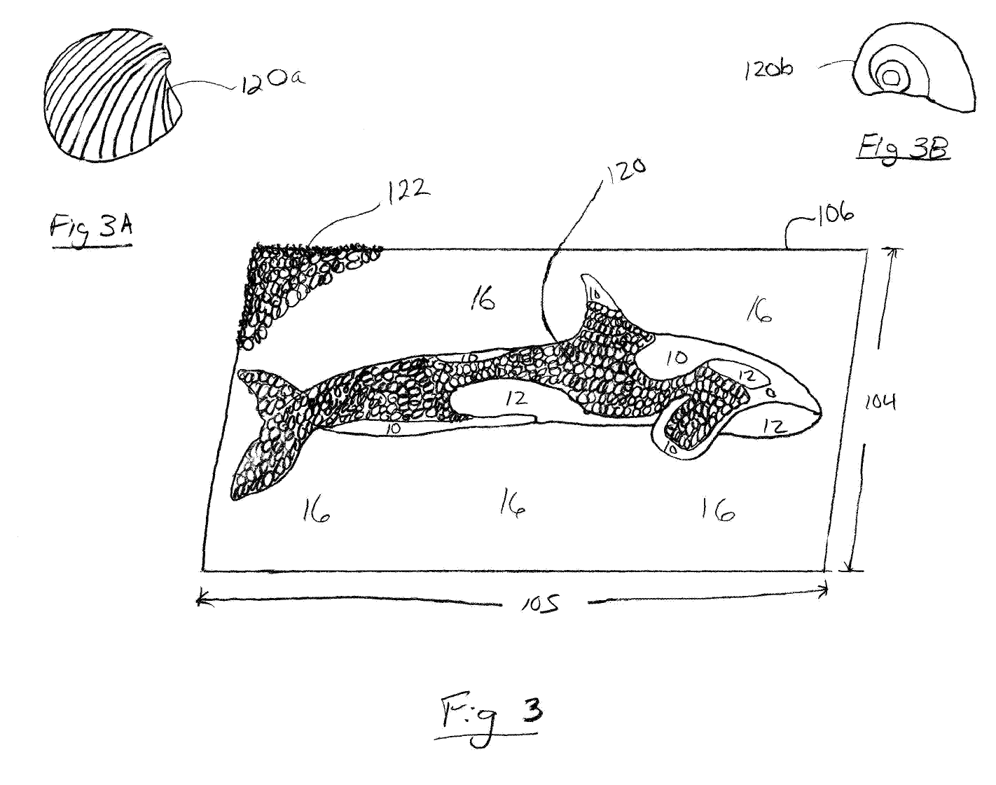

FIG. 3 shows the use of colored sea shell ground cover fill material 120, 122 on the mat 106. Sea shells provide nutrients to the soil. Sea shells are more resistant to matting down and therefore better allow air and water to permeate through the sea shells. Sea shells last longer and decompose slower than other organic mulch. Sea shells, such as exemplary sea shells 120a, 120b shown in FIG. 3B, can be used as ground cover fill material in the same manner as mulch could be used. Sea shells can be colored with paints or dyes that provide the sea shells with color but also do not obscure the textured surface of the sea shells from view.

While FIG. 3 shows the use of colored sea shell, other ground cover fill material may also be used with the mat. The sea shells may be the type that are found in and retrieved from a mine or other excavation site. The shells may be any shape or size but are typically sized in the range of 0.125 to 2.5 inches in diameter.

The landscape design is partially covered with sea shells in FIG. 3. Blue colored sea shells 122 have been placed in the upper left corner of the mat and the user will continue to fill the entire area with the fill label 16. Fill area with fill label 14 has been completely filled in with gray colored sea shells 120. To complete the landscape design the landscaper will place the appropriate colored sea shell in each remaining fill area as indicated by the corresponding fill labels. When complete, the sea shells will completely cover the mat so that the design is represented in the sea shells alone and the mat is not visible.

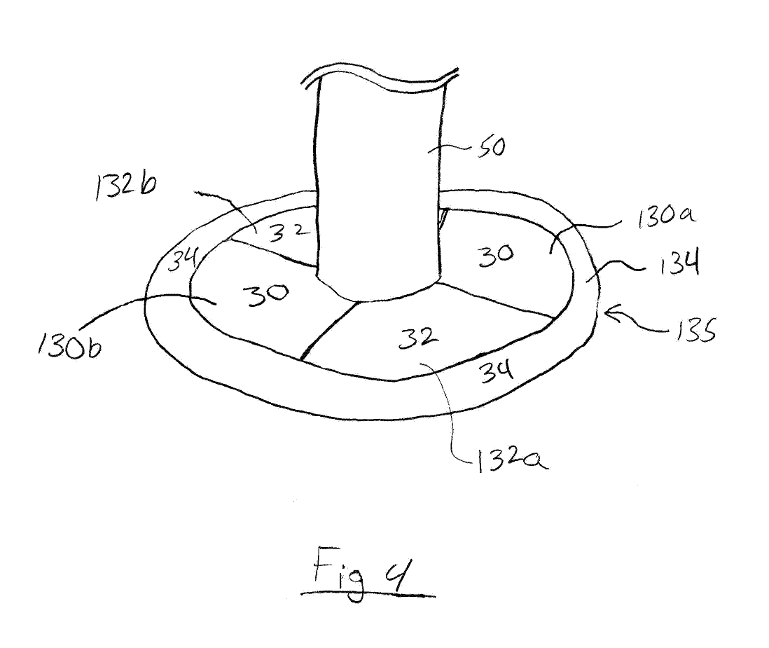

FIG. 4 shows a third embodiment mat 135. The mat 135 is circular in shape with a hole in the center to allow a tree 50 to extend through. The design on the mat is defined by fill areas 130a, 130b, 132a, 132b, 134. Each fill area has a corresponding fill label 30, 32, 34. The fill label 30 corresponds to fill areas 130a, 130b. Fill label 32 corresponds to fill areas 132a, 132b. Fill label 34 corresponds to fill area 134.

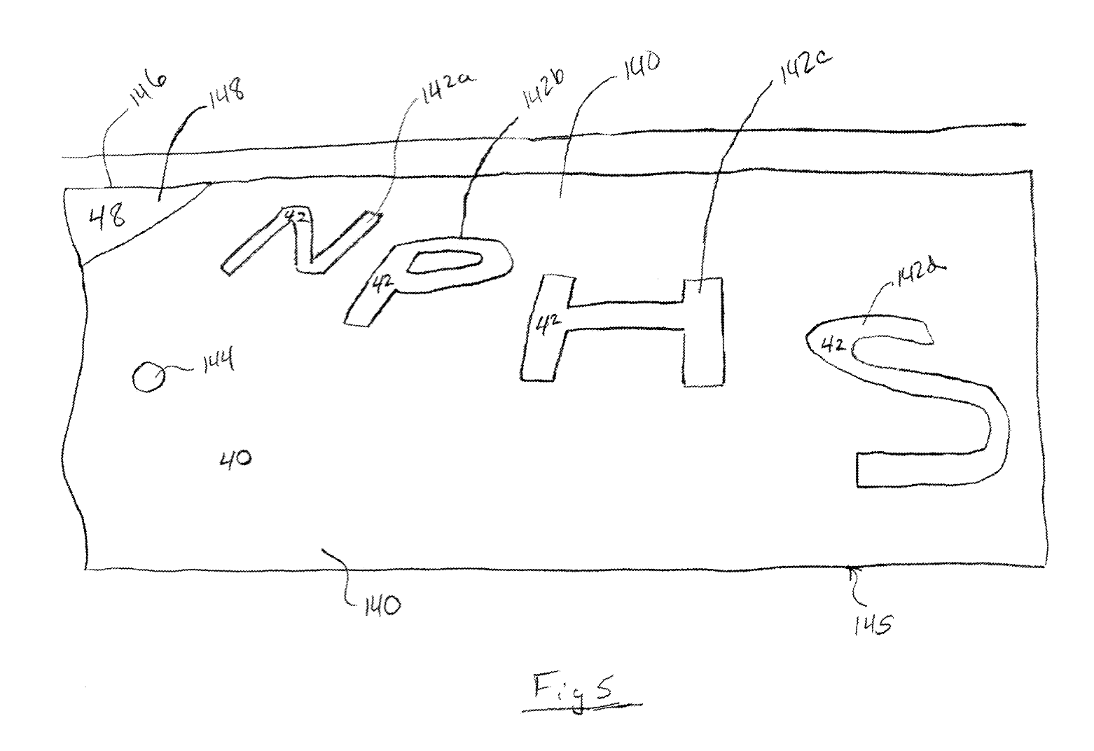

FIG. 5 shows a fourth embodiment mat 145. The design on the mat 145 is defined by fill areas 140, 142a, 142b, 142c, 142d. Fill label 40 corresponds to fill area 140. Fill labels 42 correspond to the letters NPHS in fill areas 142a, 142b, 142c, 142d respectively. Mats can be used adjacent one another for creating large scale designs. For example, mat 146 is partially viable and adjacent mat 145. The mat 146 has multiple fill areas but only one fill area 148 with fill label 48 is viable. In some embodiments, the mat has a plant location designator 144. The landscaper will then place a plant at the plant location designator before or during the placing of the ground cover fill material in the fill areas.

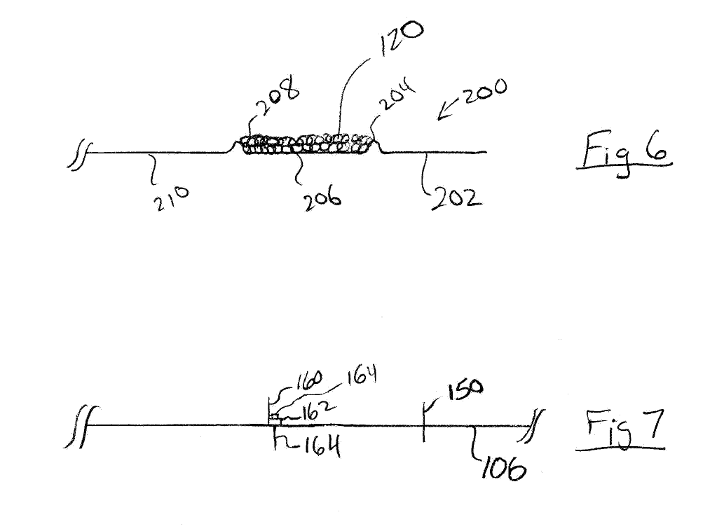

FIG. 6 shows a cross-sectional side view of an alternative embodiment mat 200. The mat is made of formed material, such as plastic, that maintains its shape. The mat has fill boundaries 204, 208, that extend above fill areas 202, 206, 210. The fill areas are recessed from the fill boundaries and create concave recesses configured to receive ground cover fill material. The mat 200 may have any design, such as the design of mat 106, and the fill areas may have fill labels. Fill area 206 is shown in FIG. 6 having been filled with sea shells. Each fill area may be filled to the extent that ground cover fill material from one fill area contacts ground cover fill material in an adjacent fill area so that the fill boundary on the mat between the adjacent fill area is not visible.

FIG. 7 provides a cross section side view of a portion of mat 106 showing two different type of dividers 150, 160. A submergible divider 150 is placed along the fill boundaries and is pressed into or through the surface of the mat 106 so that the mat 106 and/or the underlying ground can provide support to the divider. A surface divider 160 is placed on the upper surface of the mat 106, and held upright by one or more stakes 164 driven through a stake receiver 162 attached to the surface divider, and further driven through the mat 106 and into the ground to support the divider in a vertical orientation. In some embodiments, the fill boundary is a line provided on the surface of the mat.

In some embodiments, the dividers 150, 160 may be provided in the shape of the design, such as design 108, or part of the design to be assembled with other preformed dividers to form the entire design. In some embodiments, the dividers 150, 160 are flexible, and the landscaper or user will secure the dividers in place along each fill boundary to form the entire design.

Sea shells 120 for use as ground cover fill material may be colored or dyed to achieve a desired aesthetic appearance. Sea shells may be colored with dye in such a manner that the natural texture and contours of the sea shells are not obscured. The dye may be any color or combination of color. The dye may be mixed with water or other liquids. The dye may be a basic, acid, direct, sulfur, reactive, or vat type dye. The dye may be water-insoluble or water-soluble. The dye may be biodegradable. Also, sea shells may be colored with a stain, paint, or other colorant in such a manner that the natural texture and contours of the sea shells are not obscured. In some embodiments, sea shells are used as ground cover fill material without any dye or coloring.

In some embodiments, the sea shell may have a photoluminescent, a phosphorescent, or a glow-in-the-dark property via a coating, such as by the utilization of phosphorous and the slow oxidation thereof to emit light. Phosphorescent materials include zinc sulfide, strontium aluminate, and strontium oxide aluminate. In some embodiments, the sea shell may have a fluorescent coating, which reacts under long-wave unltraviolet radiation, also known as black light. The sea shell may have a gloss, pearl, or mica coating applied to the sea shell, in addition or instead of dye. Ground cover fill material including gravel, rocks, stone, or other aggregate may be dyed, colored, or coated in the same manner as just described for dying, coloring, or coating sea shells.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A landscaping ground cover system, comprising:
a ground mat having one or more fill boundaries defining a plurality of fill areas;
at least one of the plurality of fill areas having a fill label corresponding to a pre-defined ground cover fill material to be filled into the corresponding fill area.

2. The system of claim 1, wherein the fill boundaries are walls extending up from the top surface of the mat.

3. The system of claim 1, wherein the mat is a weed prevention mat permeable to water and air.

4. The system of claim 1, wherein the mat comprises polypropylene.

5. The system of claim 1, wherein the mat comprises a hard plastic and wherein the fill boundaries and fill areas are formed into the mat, the fill areas are recessed from a top of the fill boundaries.

6. The system of claim 1, wherein each fill area comprises a fill label corresponding to a given ground cover fill material to be filled into the corresponding fill area.

7. The system of claim 1, wherein the fill boundaries form a graphic design on the mat.

8. A method of landscaping, comprising the steps of:
laying a mat on an exterior surface, the mat having one or more fill boundaries defining a plurality of fill areas on the mat;
filling a first fill area of the plurality of fill areas with a first ground cover fill material; and
filling a second fill area of the plurality of fill areas with a second ground cover fill material, the first ground cover fill material differs from the second ground cover fill material by at least one characteristic.

9. The method of claim 8, wherein the steps of filling are further defined in that the at least one characteristic is a ground cover fill material color.

10. The method of claim 8, wherein the steps of filling are further defined in that the at least one characteristic is a ground cover fill material type.

11. The method of claim 8, wherein the steps of filling are further defined in that the at least one characteristic is a photoluminescence of the ground cover fill material.

12. The method of claim 8, wherein the steps of filling are further defined in that the at least one characteristic is selected from the group consisting of: fluorescence, glossiness, and pearl.

13. The method of claim 8, wherein the step of laying the mat is further defined in that each fill area of the mat comprises a fill label; and,
wherein the step of filling the first area comprises filling the first fill area with the first ground cover fill material having a first characteristic corresponding to the fill label in the first fill area;
wherein the step of filling the second area comprises filling the second fill area with the second ground cover fill material having a second characteristic corresponding to the fill label in the second fill area.

14. The method of claim 13, wherein the steps of filling are further defined in that the at least one characteristic is a ground cover fill material color.

15. The method of claim 13, further comprising the step of filling the remaining fill areas with one or more ground cover fill materials corresponding to the fill label in each remaining fill area.

16. The method of claim 13, comprising, before the step of filling, referencing a fill key to determine a ground cover fill material that corresponds to the fill label in each fill area.

17. The method of claim 8, wherein the step of laying the mat is further defined in that each fill area of the mat comprises a fill label; and
the method of landscaping further comprising, before the step of filling the first fill area, referencing a fill key to determine a ground cover fill material that corresponds to the fill label in each fill area; and,
wherein the step of filling comprises filling sea shell ground cover fill material having a first color in the first fill area, and filling sea shell ground cover fill material having a second color in the second fill area, the first color corresponding to the fill label in the first fill area and the second color corresponding to the fill label in the second fill area.

18. The method of claim 8, wherein the step of laying a mat on an exterior surface is further defined in that the exterior surface is the ground.

19. The method of claim 8, wherein the step of filling, comprises the step of completely covering the mat in each fill area with a predefined corresponding ground cover fill material.

20. A method of landscaping, comprising the steps of:
laying a mat on an exterior surface, the mat having one or more fill boundaries defining a plurality of fill areas on the mat, each fill area of the mat comprises a fill label;
filling each fill area with a given predefined ground cover fill materials corresponding to the fill label of each fill area, where the ground cover fill materials comprises at least a first ground cover fill material and a second ground cover fill material, where the first ground cover fill material differs from the second ground cover fill material by at least one characteristic.
